(19) United States
(12) Patent Application Publication
(10) Pub. No.: US 2026/0249562 A1
(43) Pub. Date: Aug. 27, 2026

(54) ADHESIVE APPLICATION SYSTEMS AND METHODS FOR USE WITH ADHESIVES

(71) Applicant: The Boeing Company, Arlington, VA (US)

(72) Inventors: Adam Nadel, Vienna, VA (US); Chathu Kuruppu, Chantilly, VA (US)

(73) Assignee: The Boeing Company, Arlington, VA (US)

(21) Appl. No.: 19/063,512

(22) Filed: Feb. 26, 2025

(51) Int. Cl. B29C 65/54; B05C 7/00

(52) U.S. Cl. CPC B29C 65/54; B05C 7/00

(57) ABSTRACT

An adhesive application system and method includes a dispensing device disposed within a gap between a first mating component and a second mating component. The dispensing device includes a body having one or more interior surfaces that define an interior cavity. The body includes an inlet passage and one or more outlet passages. The interior cavity of the body receives an adhesive via the inlet passage. The dispensing device moves within the gap between the first and second mating components. The adhesive is dispensed from the one or more outlet passages and into the gap between the first and second mating components while the dispensing device moves within the gap.

### STATEMENT OF GOVERNMENT INTEREST

This invention was made with government support under Contract Number: HR001123C0013 awarded by the Department of Defense (DOD). The government has certain rights in the invention.

### FIELD OF THE DISCLOSURE

Examples of the present disclosure generally relate to systems and methods for use in applying adhesive, such as adhesive pastes, to bond two or more mating components.

### BACKGROUND OF THE DISCLOSURE

In certain instances, adhesive pastes, such as epoxies or resins, may be used for coupling two or more mating components. The components may be used in industrial applications such as building materials, in vehicular applications such as aircraft systems or marine vessels, or the like. Currently, paste adhesive applications may use applicators which spread adhesive across surfaces which are to be bonded together. The surfaces are then brought together and the adhesive is cured per guidelines associated with a particular adhesive.

The process of bonding mating components with adhesive pastes is significantly different than the process of bonding components with adhesive films or tapes. For example, the process of applying the adhesive paste must be done in a timely manner. Adhesives start to cure once they are mixed. A time between the mixing of the adhesive materials and when the two mating surfaces need to be brought together may be referred to as the pot life. Pot lives may typically be on the order of 30 minutes to about 90 minutes. Within this pot life timeline, all of the adhesive needs to be applied to the bonding surfaces and the bonding surfaces need to be brought together. If the process is not completed within the prescribed pot life, then the bond risks having insufficient strength. This bonding process often includes a number of operators working in concert to apply the mixed adhesive paste to multiple large areas, often in a stressful environment due to the time constraints. Once the adhesive paste has been applied to the large areas of the bonding surfaces, the components to be bonded must then be moved into proper placement relative to each other. As can be appreciated, the process of applying the adhesive paste to bonding surfaces and moving the bonding surfaces into proper coupling placement without exceeding a pot life, can be difficult, stressful, and dangerous (in particular given the size of some of the mating components). Errors can lead to scrapped components if pot life times are not met, increased rework costs, etc. Moreover, repeatability of the conventional processes, while assuredly realizing an acceptable level of accuracy, would be difficult to achieve.

### SUMMARY OF THE DISCLOSURE

A need exists for an adhesive application system that can be automated and repeated with a high level of accuracy, and that can apply adhesives, such as adhesive pastes, to bonding surfaces while the mating components are already in their proper location for final assembly. By applying adhesive pastes to mating components in their final proper location, the number of operators needed to participate in the process may be reduced and the bonding process may be assuredly completed in a timely manner relative to the pot life or curing time of the adhesive pastes. For example, time may be saved by applying the adhesive pastes while the mating components are in situ, relative to applying the adhesive pastes and then moving the mating components to the proper placement for coupling.

With those needs in mind, certain examples of the present disclosure provide an adhesive application system and method that includes a dispensing device that is disposed within a gap between a first mating component and a second mating component. The dispensing device includes a body having one or more interior surfaces that define an interior cavity. The body includes an inlet passage and one or more outlet passages. The interior cavity of the body receives an adhesive via the inlet passage. The dispensing device moves within the gap between the first and second mating components. The adhesive is dispensed from the one or more outlet passages and into the gap between the first and second mating components while the dispensing device moves within the gap.

In one example, a carrier component may be operably coupled with the dispensing device and may control movement of the dispensing device within the gap. For example, the carrier component may move within the gap, and the carrier component may control movement of the dispensing device to move within the gap. Optionally, the carrier component and the dispensing device may move within the gap at a speed based on a curing time of the adhesive, a size of the one or more outlet passages, a size of the gap between the first and second mating components, a time to fill at least a portion of the gap, a chemical make-up of the adhesive, or the like. The dispensing device may move within the gap in a first direction, and the adhesive may be dispensed from the one or more outlet passages of the dispensing device in a second direction that is radial to and/or perpendicular to the first direction in which the carrier component and dispensing device move.

In one example, the adhesive may be dispensed from the outlet passages at a flow rate that is relative to one or more of a size of the gap between the first and second mating components, a number of the one or more outlet passages, or a size of each of the one or more outlet passages. In one example, the body of the dispensing device may have a tubular shape and extend a length between a first end and a second end of the body. The outlet passages may be disposed at different locations along the length of the body between the first and second ends of the body. Optionally, the one or more outlet passages may be disposed at one or more locations around a circumference of the tubular shape of the dispensing device.

In one example, the adhesive application system may include an adhesive supply source (e.g., that can include and/or represent one or more reservoirs) that is fluidly coupled with the inlet passage of the dispensing device. The reservoir may provide the adhesive to the dispensing device. In another example, the adhesive application system may include one or more fixture devices that can maintain a position of the first mating component and a position of the second mating component. Optionally, the adhesive application system may include a blocking element disposed within the gap between the first and second mating components. The blocking element may control a direction of flow of the adhesive within the gap between the first and second mating components.

Certain examples of the present disclosure provide a method that includes positioning a dispensing device within a gap between a first mating component and a second mating component. The dispensing device includes a body having one or more interior surfaces defining an interior cavity. The body includes an inlet passage and one or more outlet passages. The interior cavity of the body receives an adhesive via the inlet passage of the body. The method includes moving the dispensing device within the gap between the first and second mating components, and directing the adhesive out of the interior cavity of the body and into the gap between the first and second mating components via the one or more outlet passages during movement of the dispensing device within the gap.

Certain examples of the present disclosure provide an adhesive application system that includes one or more fixture devices that are operably coupled with a first mating component and a second mating component. The fixture devices maintain a position of a gap between the first and second mating components. A carrier component includes a body that extends between a first end and a second end in which a portion of the second end is disposed within the gap between the first and second mating components. A dispensing device is operably coupled with the carrier component and is disposed within the gap between the first and second mating components. The dispensing device includes a body having one or more interior surfaces defining an interior cavity. The body includes an inlet passage and one or more outlet passages. The interior cavity of the body receives an adhesive via the inlet passage of the body. The carrier component controls movement of the dispensing device within the gap. The adhesive is dispensed from the one or more outlet passages and into the gap between the first and second mating components during movement of the dispensing device within the gap to couple the first mating component with the second mating component.

### BRIEF DESCRIPTION OF THE DRAWINGS

FIG. 1 illustrates a perspective view of an adhesive application system, according to an example of the present disclosure.

FIG. 2 illustrates a cross-sectional front view of the adhesive application system shown in FIG. 1, according to an example of the present disclosure.

FIG. 3 illustrates a cross-sectional side view of the adhesive application system shown in FIG. 1, according to an example of the present disclosure.

FIG. 4 illustrates a cross-sectional side view of an adhesive application system, according to an example of the present disclosure.

FIG. 5 illustrates a perspective view of a dispensing device, according to an example of the present disclosure.

FIG. 6 illustrates a perspective view of a dispensing device, according to an example of the present disclosure.

FIG. 7 illustrates a flowchart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word "a" or "an" should be understood as not necessarily excluding the plural of the elements or steps. Further, references to "one example" are not intended to be interpreted as excluding the existence of additional examples that also incorporate the recited features. Moreover, unless explicitly stated to the contrary, examples "comprising" or "having" an element or a plurality of elements having a particular condition can include additional elements not having that condition.

As described herein, the examples of the present disclosure provide adhesive application systems that may be used to dispense fluid adhesives, such as adhesive pastes, within a gap between two or more mating components. The adhesive application systems may include a dispensing device having one or more outlet passages that is disposed within the gap and dispenses or directs the adhesive from the plural outlet passages while the dispensing device moves within the gap, such as in a direction away from the dispensed adhesive, i.e., in a direction such that the dispensed adhesive paste is left trailing the device. The adhesive application system may include a carrier component that may be coupled or otherwise attached to or in communication with the dispensing device and may serve to control movement of the dispensing device within the gap. It is understood by one of ordinary skill in the art that, unless otherwise stated, use of one of the terms or phrases dispenses, distributes, or directs out of, herein is intended to be inclusive of each of the other terms or phrases as well.

Optionally, the adhesive application system may include one or more fixture devices that may hold the first mating component in a fixed position and may hold the second mating component in a fixed position. For example, such fixture device(s) may maintain the first, second, and/or any number of mating components in positions that define a gap disposed therebetween. For example, the first and second mating components may be held in positions corresponding to the final placement of the components within a system (e.g., a building, a vehicle system, or the like) and the dispensing device may dispense adhesive into a gap between the mating components to serve to mate, couple, bond, join, or the like, the components together. It is understood by one of ordinary skill in the art that, unless otherwise stated, use of one of the terms mate, couple, bond, or join herein is intended to be inclusive of each of the other terms as well.

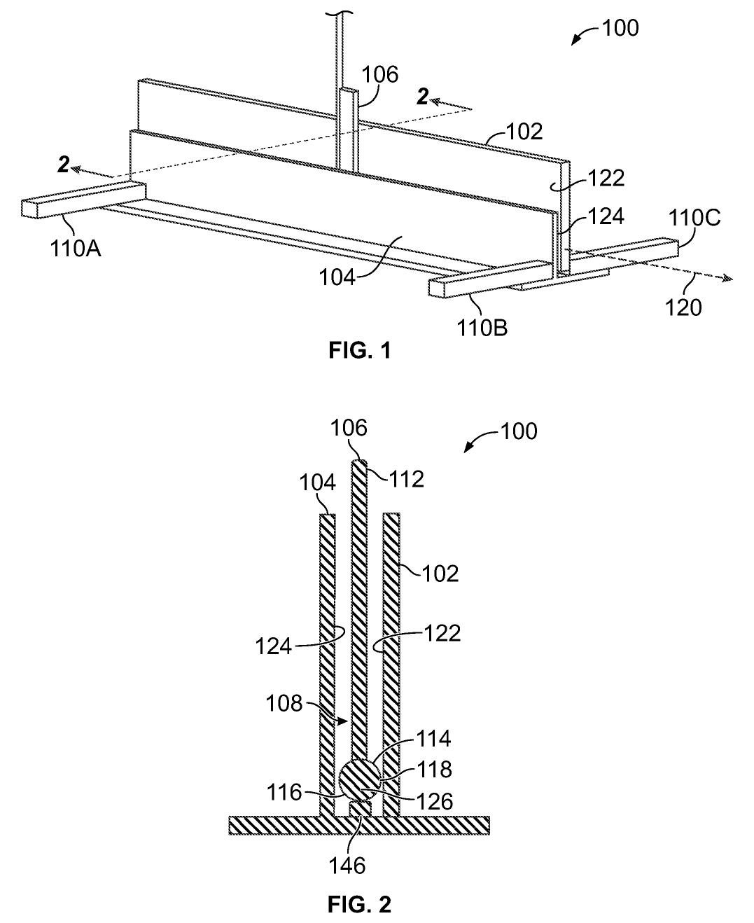

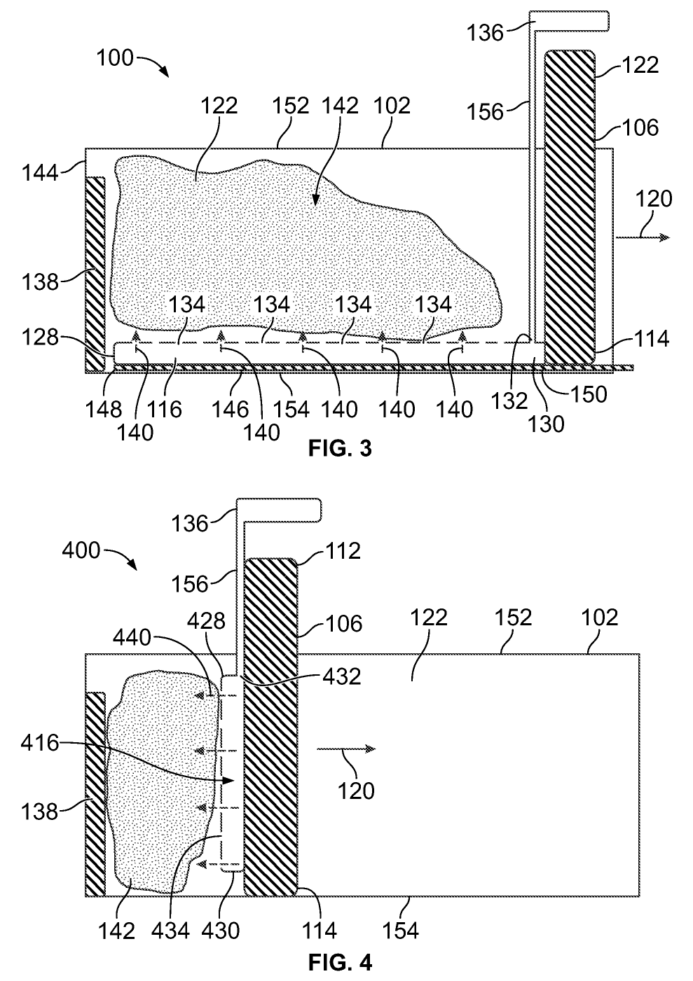

FIG. 1 illustrates a perspective view of an exemplary adhesive application system 100. FIG. 2 illustrates a cross-sectional front view of the adhesive application system 100 and FIG. 3 illustrates a cross-sectional side view of the adhesive application system 100, according to an example of the present disclosure. The adhesive application system 100 may provide a system and method for applying an adhesive to couple, join, mate, or bond a first mating component 102 with a second mating component 104. The adhesive may be a fluid adhesive, such as an adhesive paste, or the like. In another example, the system 100 may provide a method for joining or mating three or more mating components together. The illustrated example includes two mating components that are to be bonded together, however in alternative examples the adhesive application system may be used to bond, couple, mate, or the like, two or more mating components together. In one example, the first and second mating components 102, 104 may represent components of a vehicle (e.g., an aircraft or ground-based vehicle), a seacraft or other water-based craft vessel, a spacecraft, components of commercial or residential buildings or structures, or the like.

The first and second mating components 102, 104 may be held in positions relative to each other to define a gap 108 disposed between the two components. In one example, the first mating component 102 and the second mating component 104 may be held in a fixed or stationary position to maintain the size of the gap 108 between the components with one or more fixture devices 110A-C. For example, the fixture device 110A-C may hold the position of the first and second mating components 102, 104 in situ within the system in which the mating components are used. For example, the fixture devices 110A-C allow for the first and second mating components 102, 104 to be held and bonded together in a final position in which the components may be used within a system (e.g., an aircraft system). Although three fixture devices are illustrated holding two mating components in place, any suitable number of fixture devices may be used to maintain the positions of any number of mating components during an application process of an adhesive 142 (shown in FIG. 3).

The adhesive application system 100 includes a dispensing device 116 that is positioned within the gap 108 between the first and second mating components 102, 104. In the illustrated example, the dispensing device 116 has a substantially tubular cross-sectional shape with an interior surface 118 that defines an interior cavity 126. In another example, the dispensing device 116 may have a substantially rectangular cross-sectional shape, an oval cross-sectional shape, a triangular cross-sectional shape, or the like. In one example, the dispensing device 116 may be manufactured of a flexible material. In another example, the dispensing device 116 may be manufactured of a hard or rigid material, a semi-rigid material, or the like.

In the illustrated example shown in FIG. 3, the dispensing device 116 has a body that extends between a first end 128 and a second end 130 and is positioned proximate a second edge 154 of the first mating component 102. In another example, the dispensing device 116 may be positioned within the gap 108 at any location between a first edge 152 and the second edge 154 of the first mating component 102. The dispensing device 116 includes an inlet passage 132 disposed proximate the second end 130 of the body of the dispensing device. The dispensing device 116 also includes plural outlet passages 134. In the illustrated example shown in FIG. 3, the dispensing device 116 includes plural outlet passages 134 and the outlet passages 134 are disposed at different locations along the length of the body between the first and second ends 128, 130. In another example, the dispensing device 116 may include a single outlet passage that may be an opening that is positioned at a location of the body (e.g., proximate the first end 128 or the second end 130), that extends a portion of the length of the body of the dispensing device, or the like. For example, the dispensing device 116 may include a single outlet passage that is a slit that extends a length of the dispensing device 116. The inlet passage 132 may receive adhesive that may be directed into the interior cavity 126 of the dispensing device 116, and the adhesive 142 may be directed out of the interior cavity 126 via one or more of the plural outlet passages 134 and into the gap 108 between the first and second mating components 102, 104.

In one example, the inlet passage 132 may be fluidly coupled with, or otherwise in fluidic communication with, an adhesive supply source 136 via a conduit 156. The adhesive supply source 136 may represent one or more reservoirs and can include or represent one or more of a fluid control device, a holding space, or the like. As one example, the adhesive supply source 136 may include the fluid control device, such as a pump or vacuum, that may control one or more flow characteristics (e.g., flow rate, volume, or the like) of the adhesive (or the materials that are to be combined to form the adhesive) from the adhesive supply source 136 to the dispensing device 116. The fluid control device may be pneumatically powered, hydraulically powered, manually powered, or the like.

As one example, the adhesive supply source 136 may separately contain two or more materials that may be mixed or otherwise combined with each other within the adhesive supply source 136 and/or within the conduit 156 as the two or more different materials travel from the adhesive supply source 136 to the inlet passage 132. For example, the conduit 156 may include one or more elements or features (not shown) that may be shaped, sized, and positioned within an interior portion of the passage 156 to encourage the mixing of the two different epoxy or resin materials as the two materials move within the conduit 156. The features may be interior spaces, fins, or the like. As another example, the two different materials may be mixed or combined together via a mixing device (not shown) within the adhesive supply source 136. As another example, the adhesive supply source 136 may contain a reservoir of an epoxy resin (or any other resin type) material that does not require mixing with an activation agent (e.g., a hardener). For example, the adhesive may be made of a resin material that does not require mixing with an activation agent (e.g., a hardener), or may have already been pre-mixed.

In one or more examples, the adhesive 142 may be dispensed from or directed out of the outlet passages 134 of the dispensing device 116 while the dispensing device 116 moves within the gap 108 between the first and second mating components 102, 104. In one example, the dispensing device 116 may move within the gap in a first direction 120. In another example, the dispensing device 116 may move within the gap in a different direction, in two directions such as at an angle relative to a horizontal, or the like.

In one or more examples, the speed/rate of movement of the dispensing device 116 in the first direction 120 and an amount of adhesive 142 needed to dispensed into the gap 108 may be based on a size of the gap 108, such as between the first and second edges 152, 154 of the first mating component 102. For example, the amount of adhesive 142 that is dispensed from the outlet passages 134 and into the gap 108 may need to sufficiently fill the gap 108 (e.g., within about 50% of the size of the gap, within about 75% of the size of the gap, within about 90% of the size of the gap, etc.) between the first and second edges 152, 154 of the first mating component 102. The dispensing device 116 may move at a determined speed/rate to ensure that the amount of adhesive 142 dispensed from or directed out of the device 116 is enough to substantially fill the gap 108, but also so as to risk not overfilling.

In one example, the adhesive application system 100 may include a carrier component 106 that may be coupled with the dispensing device 116 and may control movement of the dispensing device 116. In the illustrated example, the carrier component 106 extends between a first end 112 and a second end 114. The first end 112 of the carrier component 106 is outside of the gap 108 between the first and second components 102, 104, and the second end 114 of the carrier component 106 is positioned within the gap 108. For example, the first end 112 of the carrier component 106 is disposed a distance away from the first edge 152 of the first mating component 102, and the second end 114 of the carrier component 106 is positioned proximate to the second edge 154 the first mating component 102.

The dispensing device 116 may be coupled with or otherwise in communications with the carrier component 106 such that movement of the carrier component 106 in a first direction 120 controls movement of the dispensing device 116 in the first direction 120 within the gap 108. For example, the carrier component 106 and the dispensing device 116 may move together or otherwise correspondingly in the first direction 120 within the gap 108 between the first and second mating components 102, 104.

In one example, the first end 112 of the carrier component 106 may be coupled with a mechanical machine or other equipment (not shown) that may mechanically control movement of the carrier component. The equipment may be hydraulically powered, pneumatically powered, electrically powered, or the like. For example, the mechanical equipment may automatically control the speed/rate at which the carrier component 106 and the dispensing device 116 move in the first direction, such as based on a predetermined speed. The predetermined speed may ensure that an appropriate amount of adhesive is dispensed into the gap, to improve repeatability of bonding operations between different mating components, to improve an accuracy of bonding the mating components, etc. Alternatively, an operator of the adhesive application system may engage with the first end 112 of the carrier component 106 to manually control movement of the carrier component 106.

Optionally, the adhesive application system 100 may include one or more sensors that may detect one or more characteristics of the adhesive 142 that is being dispensed out of the outlet passages 134. As one example, the sensors may represent a camera that may detect if at least some of the adhesive 142 has moved out of the gap 108 between the first and second mating components 102, 104, so as to ensure that the gap 108 has been sufficiently filled, filled to a predetermined level, or the like.

In one example, the second end 130 of the dispensing device 116 may be operably coupled with or in communication with the second end 114 of the carrier device 106, such as by one or more fasteners, one or more coupling processes, or the like. In another example, the carrier component 106 may include an extension portion 146 that extends between a first end 148 (that is positioned proximate to the first end 128 of the dispensing device 116) and a second end 150 (that is positioned proximate to the second end 130 of the dispensing device 116). The extension portion 146 may provide an optional spacer positioned between the mating components and the exterior surface of the dispensing device 116. For example, the extension portion 146 may be a spacer component that may separate the dispensing device 116 and/or the carrier component 106 from the second edge 154 of the first mating component 102 and a second edge of the second mating component 104. In one example, the extension portion 146 may be positioned within the gap 108 prior to the adhesive 142 being dispensed from the dispensing device 116 while the dispensing device 116 moves within the gap 108.

The fluid adhesive 142 may be dispensed from or directed out of the outlet passages 134 of the dispensing device 116 while the carrier component 106 and the dispensing device 116 move within the gap. The dispensing device 116 and the carrier component 106 may move in within the gap at a predetermined speed or rate of travel. The predetermined rate of travel may be based on a curing time of the adhesive 142, a type or classification of the adhesive 142 (or one or more materials used within a mixture of the adhesive paste 142), a chemical makeup or classification of the adhesive 142, a size of the outlet passages 134, a size of the gap 108 between the first and second mating components 102, 104, or the like. In one example, a fluid control device (not shown) associated with the adhesive supply source 136 may control a flow rate of the adhesive into the interior cavity 126 of the dispensing device 116 and out of the outlet passages 134. For example, the adhesive 142 may be directed out of the outlet passages 134 at a flow rate that is based in part on a size of the gap 108 between the mating components 102, 104, the size and/or number of the outlet passages 134, the locations of the outlet passages 134 along the length of the body of the dispensing device 116, or the like.

In one or more examples, a size of the gap between the two or more mating components may change or vary at one or more locations between the two or more mating components. For example, the gap may have a first size or volume at a first location between the mating components, and may have a different, second size or volume at a second location between the mating components. In one or more examples, the speed or rate of travel of the dispensing device 116 may change based on the size of the gap changing. For example, the rate of travel of the dispensing device may need to decrease (e.g., slow down) responsive to a size of the gap increasing, in order for a sufficient amount of adhesive to be directed out of the dispensing device to fill the larger gap. As another example, the rate of travel of the dispensing device may remain substantially unchanged responsive to the size of the gap changing, but a flow rate of the adhesive being dispensed from the dispensing device may increase such that a greater amount of adhesive is dispensed from the dispensing device, such as while the dispensing device moves within the gap that has a greater size or volume.

In the illustrated example shown in FIG. 3, the outlet passages 134 are positioned along the length of the body of the dispensing device 116 such that the adhesive 142 is directed out of the outlet passages 134 in a second direction 140 that is perpendicular, or substantially perpendicular to (e.g., within about 2 degrees, within about 5 degrees, etc.) the first direction 120. Optionally, the outlet passages 134 may be positioned along the length of the dispensing device 116 and may be positioned, shaped, and/or sized to direct the adhesive 142 out of the dispensing device 116 in one or more radial or still other directions relative to the first direction 120.

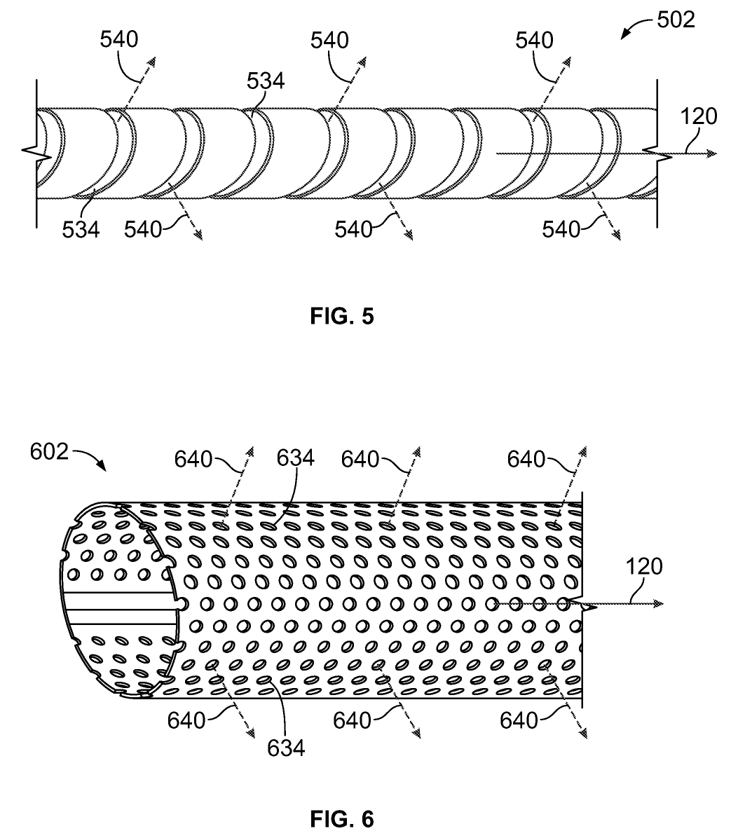

For example, FIG. 5 illustrates one example of a dispensing device 502, according to an example of the present disclosure. The dispensing device 502 has a circular cross-sectional shape but in alternative examples, the dispensing device may have an alternative cross-sectional shape (e.g., rectangular, oval, triangular, pentagon, etc.). The dispensing device 502 includes plural outlet passages 534 positioned at locations along a length of the device 502. In the illustrated example, the outlet passages 534 are positioned around a circumference of the tubular cross-sectional shape of the device 502. For example, the outlet passages 534 may include one or more spiral cuts, spiral openings, spiral slits, or the like. If one spiral cut, the single spiral cut may be a continuous cut that extends a portion of the length of the device 502 between a first end and a second end of the device. In another example, the device may include one or more non-continuous cuts, slits, passages, or the like, that may have a spiral shape or non-spiral shape. For example, the outlet passages may be shaped as one or more slits or openings that are extended along a portion of the length of the device. The adhesive may be directed out of the plural outlet passages 534 in one or more radial directions 540 relative to the first direction 120 in which the dispensing device 502 moves.

FIG. 6 illustrates a dispensing device 602, according to another example of the present disclosure. The dispensing device 602 has a circular cross-sectional shape and includes plural outlet passages 634 disposed at locations around a circumference of the circular cross-sectional shape. Although the illustrated example of the dispensing device 602 includes a circular cross-sectional shape, in another example the dispensing device may have an alternative cross-sectional shape (e.g., rectangular, oval, triangular, pentagon, etc.). In the illustrated example, the outlet passages 634 are holes that are arranged in a pattern of perforations about a center axis of the device 602. In another example, the outlet passages may be perforations arranged in a non-patterned arrangement about the circumference and/or about the length of the device 602, may be arranged on a portion of the circumference of the circular shape (e.g., one-sided, etc.), may be arranged in an arc or spiraled style around the circumference and along the length of the device, or the like. The adhesive may be directed out of the plural outlet passages 634 in one or more radial directions 640 relative to the first direction 120.

Returning to the embodiment of the adhesive application system illustrated in FIG. 3, in one example, the system 100 may include a blocking element 138 disposed between the first and second mating components 102, 104. The blocking element 138 may be positioned proximate to a side edge 144 of the first mating component 102. The blocking element may provide a barrier that controls or otherwise influences a direction of flow of the adhesive 142 that is dispensed from the outlet passages 134 of the dispensing device 116. For example, the adhesive 142 is in the form of a fluid when it is directed into the gap 108 between the mating elements 102, 104 and may harden, cure, or otherwise change to become a solid element. The adhesive may cure after a length of time, after exposure to heat, pressure, or the like. Prior to the adhesive paste curing or hardening, the blocking element 138 may be shaped, sized, and positioned within the gap 108 to control or otherwise influence a direction of flow of the adhesive 142, such as to prevent the adhesive from flowing or moving outside of the gap 108, to maintain a position of the adhesive 142 within the gap 108 until the paste has cured, or the like.

FIG. 4 illustrates an adhesive application system 400, according to one example of the present disclosure. The adhesive application system 400 includes a dispensing device 416 that includes an inlet passage 432 that receives a fluid adhesive, such as an adhesive paste, from the adhesive supply source 136, and plural outlet passages 434 that direct the adhesive 142 out of an interior cavity of the dispensing device 416. The adhesive application system 400 may also include the carrier component 106 that may be coupled with the dispensing device 416 and may control movement of the dispensing device 416 within the gap. In another example, the system 400 may be devoid of the carrier component 106, and the dispensing device 416 may be mechanically or manually controlled to move within the gap.

The dispensing device 116 of the adhesive application system 100 illustrated in FIG. 3 has a substantially horizontal arrangement such that the tubular body of the device 116 extends within the gap 108 proximate to and along the second edge 154 of the first mating component 102. Alternatively, the dispensing device 416 illustrated in FIG. 4 has a substantially vertical arrangement such that the tubular body of the device 416 extends within the gap 108 between the first edge 152 and the second edge 154 of the first mating component 102. While the carrier component 106 and the dispensing device 416 move in the first direction 120, the arrangement of the dispensing device 416 enables the adhesive 142 to be dispensed from the outlet passages 434 in a second direction 440 that is substantially parallel to and opposite of the first direction 120.

The embodiments of FIGS. 3 and 4 illustrated two examples of arrangements of an adhesive application system. Optionally, one or more components of the adhesive application system may have any alternative arrangement that includes a dispensing device that directs an adhesive out of the device while the dispensing device moves in a direction away from the adhesive paste that has been directed out of the device and into a gap between two components that are to be bonded. For example, the dispensing device may have an alternative shape, size, position or location within the gap, or the like, that enables the adhesive to move out of the dispensing device in a trailing-direction relative to a direction of movement of the device while the device dispenses the adhesive into the gap.

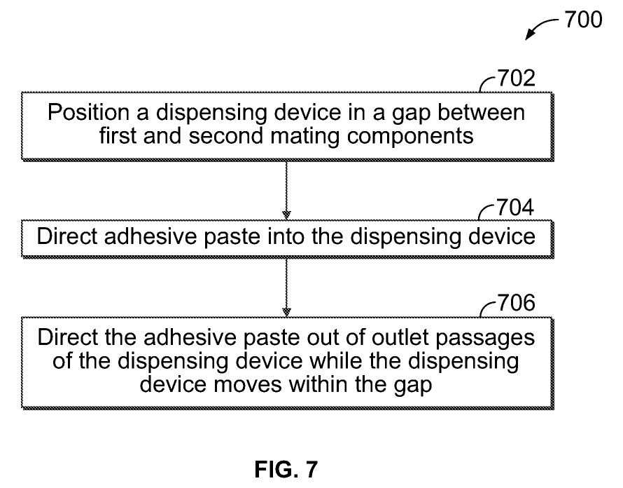

FIG. 7 illustrates one example of a flowchart of a method 700 for coupling two or more mating components together with an adhesive, according to one example of the present disclosure. At 702, a dispensing device is positioned within a gap between first and second mating components. In one example, a position of the first mating component relative to a position of the second mating component may be substantially maintained via one or more clamps or other holding fixtures. The positions of the first and second mating components (or any number of mating components) may be prearranged so as to be in the final positions that the components may be in when used within a system (e.g., an aircraft system).

At 704, an adhesive may be directed into an interior cavity of the dispensing device via an inlet passage of the dispensing device. The adhesive may be a fluid adhesive, such as a mixed adhesive paste wherein two or more different epoxy or resin materials may be mixed or combined together to form the mixed adhesive paste. The different resins may be mixed together prior to the adhesive paste being directed into the dispensing device. In another example, the adhesive may include a single epoxy or resin material that may not need to be mixed with another material.

At 706, the adhesive is dispensed from or directed out of one or more outlet passages of the dispensing device and into the gap between the first and second mating components while the dispensing device moves within the gap. For example, the dispensing device may move in a direction away from the adhesive that has been directed into the gap such that the dispensing device may continuously feed the adhesive into the gap between the mating components. The adhesive dispensed into the gap between the first and second mating components may harden to bond the first mating component with the second mating component.

As described herein, examples of the present disclosure provide adhesive application systems and methods for bonding two mating components together, in particular mating components of substantial size, such as components used within buildings, aircraft systems, marine vessels, or the like. The adhesive application systems may include one or more fixture devices that may hold positions of the two mating components in proper placement of the mating components. Additionally, the fixture devices may hold the positions of the mating components in positions that include a gap disposed between the mating components. A dispensing device may be positioned within the gap and may include plural outlet passages that may be disposed at locations along a length of the dispensing device. An adhesive is directed into the dispensing device via an inlet passage, and the adhesive is directed out of the dispensing device and into the gap via the plural outlet passages. The dispensing device moves within the gap, such as in a direction away from dispensed adhesive, while the paste is being dispensed from the outlet passages.

Examples of the present disclosure provide adhesive application systems that may be used in applying adhesive to bonding surfaces of components that are to be bonded together. The systems and methods have reduced handling times and have improved repeatability relative to known paste application systems in which adhesives are applied to bonding surfaces prior to the bonding surfaces being in a final position for bonding with mating components. Additionally, the present disclosure provides adhesive application systems that reduce the number of operators or technicians needed to complete the bonding process, thereby reducing manpower costs associated with the assembling buildings, vehicle systems, or the like.

Further, the disclosure comprises examples according to the following clauses:

Clause 1: an adhesive application system comprising:

a dispensing device configured to be disposed within a gap between a first mating component and a second mating component, the dispensing device including a body having one or more interior surfaces defining an interior cavity, the body including an inlet passage and one or more outlet passages, wherein the interior cavity of the body is configured to receive an adhesive via the inlet passage of the body,

wherein the dispensing device is configured to move within the gap between the first mating component and the second mating component, and

wherein the adhesive is configured to be dispensed from the one or more outlet passages and into the gap between the first mating component and the second mating component to couple the first mating component with the second mating component while the dispensing device moves within the gap.

Clause 2: the adhesive application system of clause 1, further comprising a carrier component configured to be operably coupled with the dispensing device, wherein the carrier component is configured to control movement of the dispensing device within the gap.

Clause 3: the adhesive application system of clause 2, wherein the carrier component is configured to move within the gap between the first and second mating components, wherein the carrier component is configured to control movement of the dispensing device to move within the gap.

Clause 4: the adhesive application system of clause 3, wherein the carrier component and the dispensing device are configured to move within the gap at a predetermined rate based on one or more of a curing time of the adhesive, a size of the one or more outlet passages of the dispensing device, a size of the gap between the first and second mating components, or a chemical make-up of the adhesive.

Clause 5: the adhesive application system of clause 3, wherein the dispensing device is configured to move within the gap in a first direction, and wherein the adhesive is configured to be dispensed from the outlet passages in a second direction that is one or more of radial to or perpendicular to the first direction.

Clause 6: the adhesive application system of any of clauses 1-5, wherein the adhesive paste is configured to be dispensed from the outlet passages at a flow rate, wherein the flow rate of the adhesive is relative to one or more of a size of the gap between the first and second mating components, a number of the one or more outlet passages, or a size of each of the one or more outlet passages.

Clause 7: the adhesive application system of any of clauses 1-6, wherein the body of the dispensing device has a cross-sectional shape and extends a length between a first end and a second end of the body.

Clause 8: the adhesive application system of clause 7, wherein the one or more outlet passages are disposed one or more of at different locations about a portion of a perimeter of the cross-sectional shape or at different locations along the length between the first and second ends of the body.

Clause 9: the adhesive application system of any of clauses 1-8, further comprising an adhesive supply source fluidly coupled with the inlet passage of the dispensing device, wherein the adhesive supply source is configured to provide the adhesive to the dispensing device.

Clause 10: the adhesive application system of any of clauses 1-9, further comprising one or more fixture devices configured to maintain a position of the first mating component and a position of the second mating component.

Clause 11: the adhesive application system of any of clauses 1-10, further comprising a blocking element disposed within the gap between the first and second mating components, the blocking element configured to control a direction of flow of the adhesive within the gap between the first and second mating components.

Clause 12: a method, comprising:

positioning a dispensing device within a gap between a first mating component and a second mating component, the dispensing device including a body having one or more interior surfaces defining an interior cavity, the body including an inlet passage and one or more outlet passages, wherein the interior cavity of the body is configured to receive an adhesive via the inlet passage of the body;

moving the dispensing device within the gap between the first mating component and the second mating component, wherein the adhesive is configured to be dispensed from the interior cavity of the body and into the gap between the first and second mating components via the one or more outlet passages to couple the first mating component with the second mating component during movement of the dispensing device within the gap.

Clause 13: the method of clause 12, wherein the dispensing device is configured to be operably coupled with a carrier component, and further comprising controlling movement of the dispensing device in the first direction within the gap with the carrier component.

Clause 14: the method of clause 13, further comprising:

moving the carrier component and the dispensing device in a first direction within the gap between the first and second mating components; and

directing the adhesive out of the one or more outlet passages in a second direction.

Clause 15: the method of clause 14, wherein the second direction is one or more of radial relative to the first direction or substantially perpendicular to the first direction.

Clause 16: the method of clause 12, further comprising moving the dispensing device within the gap at a predetermined rate based on one or more of a curing time of the adhesive, a size of the one or more outlet passages of the dispensing device, a size of the gap between the first and second mating components, or a chemical make-up of the adhesive.

Clause 17: an adhesive application system comprising:

one or more fixture devices configured to be operably coupled with a first mating component and a second mating component, the one or more fixture devices configured to maintain a position of a gap between the first mating component and the second mating component;

a carrier component having a body extending between a first end and second end, wherein a portion of the second end is configured to be disposed within the gap between the first and second mating components; and

a dispensing device configured to be operably coupled with the second end of the carrier component, the dispensing device configured to be disposed within the gap between the first and second mating components, the dispensing device including a body having one or more interior surfaces defining an interior cavity, the body including an inlet passage and one or more outlet passages, wherein the interior cavity of the body is configured to receive an adhesive via the inlet passage of the body,

wherein the carrier component is configured to control movement of the dispensing device within the gap, and

wherein the adhesive is configured to be dispensed from the one or more outlet passages and into the gap between the first mating component and the second mating component to couple the first mating component with the second mating component during movement of the dispensing device within the gap.

Clause 18: the adhesive application system of clause 17, further comprising an adhesive supply source fluidly coupled with the inlet passage of the dispensing device, wherein the adhesive supply source is configured to provide the adhesive to the dispensing device.

Clause 19: the adhesive application system of clauses 17 or 18, further comprising a blocking element disposed within the gap between the first and second mating components, the blocking element configured to control a direction of flow of the adhesive within the gap between the first and second mating components.

Clause 20: the adhesive application system of any of clauses 17-19, wherein the body of the dispensing device has a cross-sectional shape and extends a length between a first end and a second end of the body, wherein the one or more outlet passages are disposed one or more of at different locations along the length between the first and second ends of the body or around a portion of a perimeter of the cross-sectional shape of the dispensing device.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms "including" and "in which" are used as the plain-English equivalents of the respective terms "comprising" and "wherein." Moreover, the terms "first," "second," and "third," etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An adhesive application system comprising:
a dispensing device configured to be disposed within a gap between a first mating component and a second mating component, the dispensing device including a body having one or more interior surfaces defining an interior cavity, the body including an inlet passage and one or more outlet passages, wherein the interior cavity of the body is configured to receive an adhesive via the inlet passage of the body,
wherein the dispensing device is configured to move within the gap between the first mating component and the second mating component, and
wherein the adhesive is configured to be dispensed from the one or more outlet passages and into the gap between the first mating component and the second mating component while the dispensing device moves within the gap.

2. The adhesive application system of claim 1, further comprising a carrier component configured to be in communication with the dispensing device, wherein the carrier component is configured to control movement of the dispensing device within the gap.

3. The adhesive application system of claim 2, wherein the carrier component is configured to move within the gap between the first and second mating components, and wherein the carrier component is configured to control movement of the dispensing device to move within the gap.

4. The adhesive application system of claim 3, wherein the carrier component and the dispensing device are configured to move within the gap at a predetermined rate based on one or more of a curing time of the adhesive, a size of the one or more outlet passages of the dispensing device, a size of the gap between the first and second mating components, a time to fill at least a portion of the gap, or a chemical make-up of the adhesive.

5. The adhesive application system of claim 3, wherein the dispensing device is configured to move in a first direction within the gap, and wherein the adhesive is configured to be dispensed from the one or more outlet passages in a second direction that is one or more of radial to or perpendicular to the first direction.

6. The adhesive application system of claim 1, wherein the adhesive is configured to be dispensed from the one or more outlet passages at a predetermined flow rate, wherein the predetermined flow rate of the adhesive is relative to one or more of a size of the gap between the first and second mating components, a number of the one or more outlet passages, or a size of each of the one or more outlet passages.

7. The adhesive application system of claim 1, wherein the body of the dispensing device has a cross-sectional shape and extends a length between a first end and a second end of the body.

8. The adhesive application system of claim 7, wherein the one or more outlet passages are disposed one or more of at different locations about a portion of a perimeter of the cross-sectional shape or at different locations along the length between the first and second ends of the body.

9. The adhesive application system of claim 1, further comprising an adhesive supply source fluidly coupled with the inlet passage of the dispensing device, wherein the adhesive supply source is configured to provide the adhesive to the dispensing device.

10. The adhesive application system of claim 1, further comprising one or more fixture devices configured to maintain a position of the first mating component and a position of the second mating component.

11. The adhesive application system of claim 1, further comprising a blocking element disposed within the gap between the first and second mating components, the blocking element configured to control a direction of flow of the adhesive within the gap between the first and second mating components.

12. A method, comprising:
positioning a dispensing device within a gap between a first mating component and a second mating component, the dispensing device including a body having one or more interior surfaces defining an interior cavity, the body including an inlet passage and one or more outlet passages, wherein the interior cavity of the body is configured to receive an adhesive via the inlet passage of the body; and
moving the dispensing device within the gap between the first mating component and the second mating component, wherein the adhesive is configured to be dispensed from the interior cavity of the body and into the gap between the first and second mating components via the one or more outlet passages during movement of the dispensing device within the gap.

13. The method of claim 12, wherein the dispensing device is configured to be in communication with a carrier component, and further comprising controlling movement of the dispensing device within the gap with the carrier component.

14. The method of claim 13, further comprising:
moving the carrier component and the dispensing device in a first direction within the gap between the first and second mating components, wherein the adhesive is configured to be dispensed from the one or more outlet passages in a second direction.

15. The method of claim 14, wherein the second direction is one or more of radial relative to the first direction or substantially perpendicular to the first direction.

16. The method of claim 12, further comprising moving the dispensing device within the gap at a predetermined rate based on one or more of a curing time of the adhesive, a size of the one or more outlet passages of the dispensing device, a size of the gap between the first and second mating components, a time to fill at least a portion of the gap, or a chemical make-up of the adhesive.

17. An adhesive application system comprising:
one or more fixture devices configured to be in communication with a first mating component and a second mating component, the one or more fixture devices configured to maintain a position of a gap between the first mating component and the second mating component;
a carrier component having a body extending between a first end and second end, wherein a portion of the second end is configured to be disposed within the gap between the first and second mating components; and
a dispensing device configured to be in communication with the carrier component, the dispensing device configured to be disposed within the gap between the first and second mating components, the dispensing device including a body having one or more interior surfaces defining an interior cavity, the body including an inlet passage and one or more outlet passages, wherein the interior cavity of the body is configured to receive an adhesive via the inlet passage of the body,
wherein the carrier component is configured to control movement of the dispensing device within the gap, and
wherein the adhesive is configured to be dispensed from the one or more outlet passages and into the gap between the first mating component and the second mating component during movement of the dispensing device within the gap.

18. The adhesive application system of claim 17, further comprising an adhesive supply source fluidly coupled with the inlet passage of the dispensing device, wherein the adhesive supply source is configured to provide the adhesive to the dispensing device.

19. The adhesive application system of claim 17, further comprising a blocking element disposed within the gap between the first and second mating components, the blocking element configured to control a direction of flow of the adhesive within the gap between the first and second mating components.

20. The adhesive application system of claim 17, wherein the body of the dispensing device has a cross-sectional shape and extends a length between a first end and a second end of the body, wherein the one or more outlet passages are disposed one or more of at different locations along the length between the first and second ends of the body or around a portion of a perimeter of the cross-sectional shape of the dispensing device.
